(19) United States
(12) Patent Application Publication
(10) Pub. No.: US 2009/0296745 A1
(43) Pub. Date: Dec. 3, 2009

(54) HIGH-POWER FIBER AMPLIFIER EMPLOYING MULTI-POINT PUMP COUPLING VIA COILED GAIN FIBER

(75) Inventors: Theodore F. Morse, Boston, MA (US); Fei Luo, Winchester, MA (US); Xiaojun Li, Nanjing (CN)

Correspondence Address: BAINWOOD HUANG & ASSOCIATES LLC, 2 CONNECTOR ROAD, WESTBOROUGH, MA, 01581, US

(73) Assignee: TRUSTEES OF BOSTON UNIVERSITY, Boston, MA (US)

(21) Appl. No.: 12/373,589

(22) PCT Filed: Jul. 13, 2007
(86) PCT No.: PCT/US07/15978

§ 371 Date: Jan. 13, 2009

Related U.S. Application Data
(60) Provisional application No. 60/830,901, filed on Jul. 14, 2006.

(51) Int. Cl. H01S 3/30; H01S 3/00

(52) U.S. Cl. 372/6; 359/341.3

(57) ABSTRACT

An apparatus that may be used as part of an optical amplifier or laser includes a pump fiber carrying pump light from a pump source and a clad gain fiber which includes a number of coils arranged with the pump fiber to form a pump coupler. The pump coupler includes (i) a coupling section of the pump fiber, (ii) a coupling section of each of the coils of the gain fiber arranged adjacent to the coupling section of the pump fiber, (iii) an index- matching material disposed between the coupling section of the pump fiber and the coupling sections of the gain fiber to provide a high degree of coupling of the pump light from the pump fiber to the gain fiber, and (iv) a low-index material at outward-facing surfaces of the coupling sections of the gain fiber. The coupling sections of the pump fiber and of the coils of the gain fiber along with the index-matching material form a waveguide exhibiting an oscillating characteristic of coupling efficiency versus coupling length. The lengths of the coupling sections are selected to correspond to a selected maximum of the oscillating characteristic for high-efficiency coupling of the pump light from the pump fiber to the gain fiber in the pump coupler.

### BACKGROUND

The present invention relates to the field of optical fiber amplifiers and lasers.

The problem of coupling multimode radiation (such as pump radiation) into double clad optical fiber amplifiers or lasers becomes of increasing significance with demands for increased output power. There are at present several techniques for coupling of radiation into a double clad fiber. These include tapered bundles in which a central fiber and multiple surrounding fibers are tapered down to a single port which is butt-coupled to a double clad fiber of the same diameter. The central fiber can be a single mode fiber that can serve as a seed source in an amplifier configuration, or all fibers might carry pump light used to pump the gain fiber. These tapered-bundle devices can be placed at intervals along the gain fiber for increased power.

Another technique employs “notches” on the double clad fiber so that external diode radiation can be sent into the double clad fiber core from the side via the notches. Another technique is a side coupling technique developed by IPG Photonics. In this case the fiber connected diode outputs are tapered and fused around the double clad fiber so that light is efficiently coupled into the first cladding. Yet another technique has been proposed as the LG Wave Technique of University of Southampton. In this, technique, preforms of individual double clad fibers and diode-pump fibers are drawn together in a large number of configurations such that the pump light can ultimately be transferred into the first cladding of the double clad fibers.

In U.S. Pat. No. 6,826,335 of Grudinin et al., an optical fiber arrangement has at least two optical fiber sections, each optical fiber section defining an outside longitudinally extending surface. The outside longitudinally extending surfaces are in optical contact with each other. An amplifying optical device has such an optical fiber arrangement and a pump source, and is configured such that the pump source illuminates the amplifying optical fiber. An amplifying optical device comprises a plurality of pump optical fibers 221 and a plurality of amplifying optical fibers 222, in which at least one end of the pump optical fibers 221 are connected to a pump source 302 supplying pump energy, and in which the optical fiber arrangement 70 is configured such that a portion of the optical energy guided by each of the pump optical fibers 221 is coupled into at least one of the amplifying optical fibers 222, and in which at least two amplifying optical fibers 222 are connected together.

### SUMMARY

An apparatus that may be used as part of an optical amplifier or laser includes a pump fiber that carries pump light from a pump source and a gain fiber which includes a number of coils arranged with the pump fiber to form a pump coupler for coupling the pump light into the gain fiber. Specifically, the pump coupler includes (i) a coupling section of the pump fiber, (ii) a coupling section of each of the coils of the gain fiber immediately adjacent to the coupling section of the pump fiber, (iii) an index-matching material disposed between the coupling section of the pump fiber and the coupling sections of the gain fiber to provide a high degree of coupling of the pump light from the coupling section of the pump fiber to the coupling sections of the gain fiber, and (iv) a low-index material at outward-facing surfaces of the coupling sections of the gain fiber. The coupling sections of the pump fiber and of the coils of the gain fiber along with the index-matching material form a waveguide exhibiting an oscillating characteristic of coupling efficiency versus coupling length. The lengths of the coupling sections are selected to correspond to a selected maximum of the oscillating characteristic for high-efficiency coupling of the pump light from the pump fiber to the gain fiber in the pump coupler. Alternative embodiments exhibiting different ways of realizing the pump coupler are disclosed.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1 is a schematic block diagram of a fiber laser in accordance with an embodiment of the present invention;

FIG. 2(a) is a diagram of a 7×7 optical coupler that can be used to realize a pump coupler in the fiber laser of FIG. 1;

FIG. 2(b) is a diagram showing how the 7×7 coupler of FIG. 2(a) can be used to realize the pump coupler in the fiber laser of FIG. 1;

FIG. 3 is a cross-sectional view of an embodiment of the pump coupler of FIG. 1; and

FIG. 4 is a plot illustrating coupling efficiency versus length or position for a pump coupler such as shown in FIG. 3.

### DETAILED DESCRIPTION

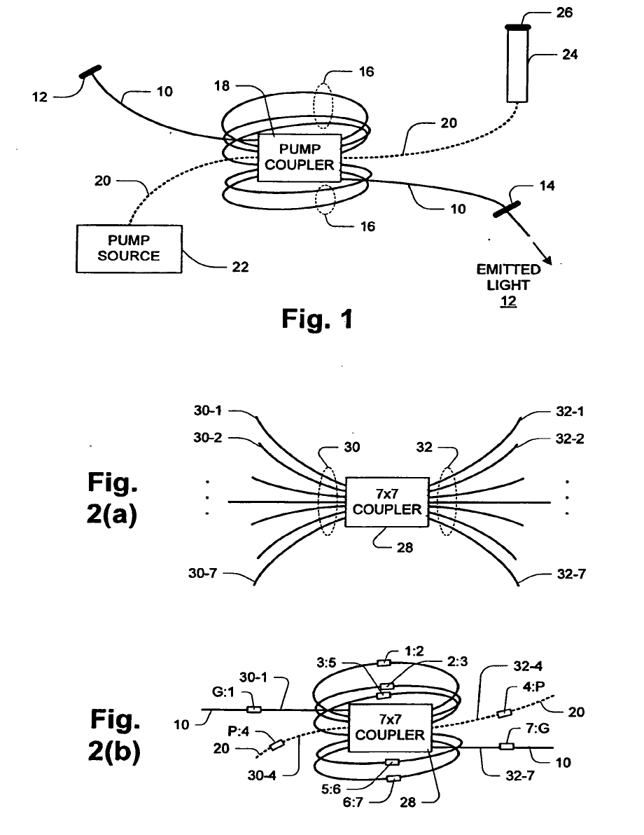

FIG. 1 shows a high-power fiber laser system having a gain optical fiber (or gain fiber) 10 serving as a lasing medium for generating emitted light. The fiber laser includes a fully reflective mirror 12 at one end of the gain fiber 10 and a partially reflective mirror 14 at the other end. The gain fiber 10 includes a number of loops or turns which are referred to collectively as loops 16. The loops 16 pass through a pump coupler 18 along with a pump optical fiber (or pump fiber) 20. At one end the pump fiber 20 is coupled to a pump source 22 which may include, for example, a plurality of laser diodes as sources of pump light carried by the pump fiber 20. At the other end the pump fiber 20 is coupled to a ferrule 24 and mirror 26. As described below, most of the pump light is coupled from the pump fiber 20 into the loops 16 of the gain fiber 10 within the pump coupler 18. Residual pump light is reflected by the mirror 26 and directed back into the pump coupler 18. Alternately, another pump source may replace the ferrule 24 and mirror 26.

The arrangement in FIG. 1 effects distributed pumping of the gain fiber 20. The pump fiber 20 and each coil 16 of the gain fiber IO each have a respective section (denoted a “coupling section”) within the pump coupler 18, and the coupling section of each coil 16 is immediately adjacent to the coupling section of the pump fiber 20 such that pump light is coupled from the pump fiber 20 into the gain fiber 10 at the coupling section of each coil 16. Each coil 16 receives a fraction I/C of the power of the pump light, where C is the number of coils 16. Overall, the gain fiber 10 receives [C×(1/C)] or about 100% of the power of the pump light, but the distributed coupling avoids the undesirably high temperature associated with coupling all of the pump light into the gain fiber at a single location.

FIG. 2 illustrates one way to realize the pump coupler 18 of FIG. 1. FIG. 2(a) shows a 7×7 coupler 28 which may be a fused taper coupler for example. Seven input fibers 30 and seven output fibers 32 are shown. FIG. 2(b) illustrates a manner of interconnecting the fibers 30 and 32 with the gain fiber 10 and pump fiber 20 to realize the configuration of FIG. 1. Specifically, the pump fiber 20 is coupled to the input fiber 30-4 and to the output fiber 32-4 for example, using end couplers which are identified in FIG. 2(b) by the number pairs (X:Y), where X identifies an output fiber 32 and Y identifies an input fiber 30. Thus for example the coupler 1:2 couples output fiber 32-1 to input fiber 30-2, etc. It will be appreciated that the fibers 30 and 32 as coupled together in FIG. 2(b) form the loops 16 of FIG. 1. That is, light propagating into the input fiber 30-1 from the gain fiber 10 via the coupler G:1 travels along a five-loop path including the couplers 1:2, 2:3,3:5, 5:6 and 6:7 in succession, then re-enters the gain fiber 10 via the output fiber 32-7 and the coupler 7:G.

It will also be appreciated that the fibers 30 and 32 of FIG. 2 can be viewed as extensions of either the gain fiber 10 or pump fiber 20 as appropriate. When coupled together as in FIG. 2(b), for example, the fibers 30-1 through 30-3, 30-5 through 30-7, 32-1 through 32-3 and 32-5 through 30-7 form part of the gain fiber 10 insofar as they carry, and help effect the amplification of the optical signal. Likewise the fibers 30-4 and 324 form part of the pump fiber 20 insofar as they carry the pump light.

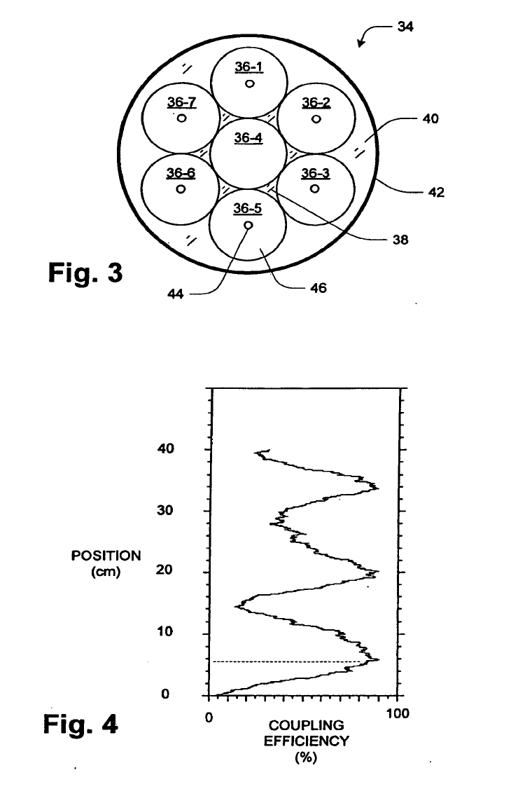

FIG. 3 shows a schematic cross-sectional view of an embodiment 34 of the pump coupler 18. Seven fiber sections 36 are placed as shown, with an inner fiber section 364 surrounded by six outer fiber sections 36-1 through 36-3 and 36-5 through 36-7. The pump and amplifier fibers need not be of the same diameter, thus the number of gain fiber coils is somewhat arbitrary. This arrangement is maintained along a desired axial length (perpendicular to the page of FIG. 3) on the order of several centimeters as described below. An index-matching material 38 is disposed between the fiber sections 36 to provide for optical coupling between the inner fiber section 36-4 and the outer fiber sections 36-1 through 36-3 and 36-5 through 36-7. The index-matching material 38 may be silica for example, formed using a sol-gel process. As indicated below, index matching may also be achieved by lightly fusing the silica fibers themselves so as not to distort the core, or by using a transparent, index-matching polymer. A low-index material 40 (such as a low-index polymer material) is disposed around the outside of the outer sections 36-1 through 36-3 and 36-5 through 36-7. An outer jacket 42 is also preferably used to enhance the mechanical strength and integrity of the overall assembly.

It will be observed that each of the outer fiber sections 36-1 through 36-3 and 36-5 through 36-7 has a core 44 surrounded by a cladding 46. In the embodiment of FIG. 3, the inner fiber section 364 does not have a core, but it may in alternative embodiments. In operation, pump light carried by the inner fiber section 364 is coupled to the core 44 of each of the outer fiber sections 36-1 through 36-3 and 36-5 through 36-7 of the pump coupler 34, where the pump light is absorbed and causes the desired amplification of the optical signal carried by the gain fiber 10 (FIGS. 1 and 2(b)).

With the exception of the cores 44, the fibers 36 and index-matching material 38 have substantially the same index of refraction. Thus, the illustrated arrangement can be modeled, in the lowest order, as a cylinder in which radiation is injected in a central region. Simulation software can be used to calculate the distance required for the radiation to couple radially from the central region (corresponding to the inner fiber section 36-4) to the outer region (corresponding to the outer fiber sections 36-1 through 36-3 and 36-5 through 36-7). Calculations show that at about 5 cm (for a typical case), approximately 90% of the centrally injected radiation has been coupled to the outer region. Since the path of the single mode core is a helix passing through the coupler 18 multiple times, pump radiation is being introduced in a more distributed manner along the gain fiber 10, which can serve to mitigate thermal problems.

FIG. 4 is a plot illustrating a spatially varying or oscillating characteristic of the coupling of pump light from the pump fiber 20 to the gain fiber 10 effected by the pump coupler 18 (including the embodiment 34 of FIG. 3). The coupler 18 acts as a waveguide in which the pump light couples back and forth between the fiber section carrying the pump light (e.g., inner fiber section 36-4 of pump coupler 34) and the fiber sections carrying the optical signal being amplified by the energy from the pump light (e.g., outer fiber sections 36-1 through 36-3 and 36-5 through 36-7 of pump coupler 34). Thus the coupling efficiency (of transfer of pump radiation to the coil of gain fiber) is a function of position along the coupler 18 from the input side (i.e., the left side in FIG. 1). As shown, the coupling efficiency reaches relative maxima of about 90% at positions of 5, 20 and 35 cm., and relative minima of 10-30% at positions of 15, 28 and 40 cm. To achieve high coupling efficiency, therefore, the axial length of the pump coupler 18 is selected to coincide with one of the maxima. In many cases, it will be desired to select the first maximum at about 5 cm., so that the overall size of the pump coupler 18 is minimized and therefore material and related costs are likewise minimized. In alternative embodiments there may be reasons to select a length coinciding with another maximum of the coupling efficiency.

In applications of fiber amplifiers and fiber lasers which involve end-coupling of pump light from a pump fiber into a gain fiber, one concern is to protect the pump diodes in the pump source from back-coupled optical radiation from the gain fiber. Pump diodes are expensive and can be damaged at high power levels. It is known to use separate optical isolators disposed between the pump diodes and the gain fiber to provide the desired protection, but such isolators add to the cost of the system. In the arrangement described herein, the signal radiation developed in the core of the gain fiber 10 is inherently isolated from the pump fiber leading to the pump diodes, so there is little or no possibility of diode damage. As an added measure, it may be desirable to employ a special fiber as the pump fiber, one that is transmissive at the wavelength of the pump light and absorptive at the wavelength of the laser or amplifier light. For example, the pump fiber may a samarium-doped (Sm-doped) glass fiber that transmits at a pump wavelength of 980 nm. and absorbs at a lasing wavelength of 1060 nm.

While various embodiments of the invention have been particularly shown and described, it will be understood by those skilled in the art that various changes in form and details may be made therein without departing from the spirit and scope of the invention as defined by the appended claims. For example, the pump coupler is disclosed as part of a laser which serves as the source of an emitted optical signal, but in alternative embodiments the pump coupler may form part of an optical amplifier that amplifies a separately generated optical signal. Although in the illustrated embodiment there is shown a central fiber surrounded by six fibers of the same diameter, the disclosed technique applies to systems in which the central pump fiber has a different diameter from the coiled gain fiber. There may be a different number of outer fiber sections in the coupler (and thus a different number of coils of the gain fiber) in alternative embodiments, and this number might be influenced in part based on the ratio of the diameter of the central pump fiber to the diameters of the outer pump fibers.

In another aspect, the index-matching material 38 may be an optical epoxy. Alternatively, the index-matching material may actually be the material of the cladding 46 (FIG. 3), as a result of slightly fusing the fiber sections 36 together very slightly at an elevated temperature. Other alternatives are also possible.

What is claimed is:

1. Apparatus, comprising:
a pump fiber operative to carry pump light from a pump source;
a clad gain fiber having a plurality of coils arranged with the pump fiber to form a pump coupler for coupling the pump light into the gain fiber, the pump coupler including:
(i) a coupling section of the pump fiber;
(ii) a coupling section of each of the coils of the gain fiber immediately adjacent to the coupling section of the pump fiber, the lengths of the coupling sections corresponding to a selected maximum of an oscillating characteristic of coupling efficiency versus coupling length for coupling the pump light from the pump fiber to the gain fiber in the pump coupler,
(iii) an index-matching material disposed between the coupling section of the pump fiber and the coupling sections of the gain fiber to provide a high degree of coupling of the pump light from the coupling section of the pump fiber to the coupling sections of the gain fiber; and
(iv) a low-index material at outward-facing surfaces of the coupling sections of the gain fiber such that the coupling sections of the pump fiber and of the coils of the gain fiber along with the index-matching material form a waveguide exhibiting the oscillating characteristic of coupling efficiency versus coupling length.

2. Apparatus according to claim 1 wherein the pump coupler is realized by an optical coupler having input fibers and output fibers, and selected ones of the input fibers are end-coupled to selected ones of the output fibers to form the coils of the gain fiber.

3. Apparatus according to claim 1 wherein the index-matching material comprises a material separate from a material of the coupling sections.

4. Apparatus according to claim 3 wherein the separate material comprises a silica glass.

5. Apparatus according to claim 3 wherein the separate material comprises an optical epoxy.

6. Apparatus according to claim 1 wherein the coupling sections are slightly fused together such that the index-matching material comprises a material of the coupling sections.

7. Apparatus according to claim 1 wherein the selected maximum of the oscillating characteristic is a first maximum corresponding to a shortest axial length of the pump coupler at which a relative maximum of the coupling efficiency occurs.

8. Apparatus according to claim 7 wherein the axial length of the pump coupler is substantially 5 cm.

9. A laser, comprising:
the apparatus of claim 1; and
mirrors arranged at respective ends of the clad gain fiber to provide a desired amount of optical feedback within the gain fiber to promote optical oscillation at a lasing wavelength.

10. An optical amplifier, comprising:
the apparatus of claim 1; and
a source of an optical signal to be amplified, the source being coupled to the gain fiber such that the optical signal is carried and amplified by the gain fiber.
